(19) United States
(12) Patent Application Publication
(10) Pub. No.: US 2020/0326940 A1
(43) Pub. Date: Oct. 15, 2020

(54) DATA LOADING AND STORAGE INSTRUCTION PROCESSING METHOD AND DEVICE

(71) Applicant: Alibaba Group Holding Limited, Georgetown (KY)

(72) Inventors: Yubo GUO, Hangzhou (CN); Zhijian CHEN, Hangzhou (CN); Jiahui LUO, Hangzhou (CN); Wenmeng ZHANG, Hangzhou (CN); Manzhou WANG, Hangzhou (CN)

(21) Appl. No.: 16/845,828

(22) Filed: Apr. 10, 2020

(30) Foreign Application Priority Data
Apr. 12, 2019 (CN) 201910292612.5

(51) Int. Cl. G06F 9/30

(52) U.S. Cl. CPC G06F 9/3016; G06F 9/30101; G06F 9/30152; G06F 9/30196; G06F 9/30036

(57) ABSTRACT

The present invention discloses an instruction processing device, including a first register adapted to store a source data address, a second register adapted to store a source data length, a third vector register adapted to store target data, a decoder and an execution unit. The decoder is adapted to receive and decode a data loading instruction. The data loading instruction instructs that the first register serves as a first operand, the second register serves as a second operand, and the third vector register serves as a third operand. The execution unit is coupled to the first register, the second register, the third vector register and the decoder, and executes the decoded data loading instruction, so as to acquire the source data address from the first register, acquire the source data length from the second register, acquire data with a start address being the source data address and a length being based on the source data length from a memory coupled to the instruction processing device, and store the acquired data as the target data in the third vector register. The present invention further discloses, an instruction processing device for processing a corresponding data storage instruction, an instruction processing method and a computing system.

### CROSS-REFERENCE TO RELATED APPLICATIONS

This Application claims priority to Chinese Patent Application No. 201910292612.5 filed Apr. 12, 2019, which is incorporated herein in its entirety.

### TECHNICAL FIELD

The present invention relates to the field of processors, in particular to a processor core having an instruction set of data loading and storage instructions, and a processor.

### BACKGR0UND

In the running process of a processor, data needs to be acquired from an external memory, and a large number of operation results are also stored in the external memory. Only by providing data for operational instructions as soon as possible and storing results, can the processor run efficiently. Loading and storage instructions are instructions for the processor to perform data transport between registers and the external memory. Data loading refers to that the processor transports data from the external memory to an internal register, and data storage refers to that the processor transports data in the internal register to the external memory.

SIMD instructions, which can perform the same operation on groups of data in parallel, are widely used in VDSP instructions of a vector digital signal processing instruction set. Data loading and storage instructions corresponding to SIMD need to load or store data of a plurality of elements each time. In many application scenarios of digital signal processing, because the amount of operational data needed by users is huge and the lengths are different, great flexibility is needed in operational data preparation and storage. For the existing fixed-length data loading and storage instructions, when data loading and storage are performed, a plurality of instructions need to be used to load data and then to combine data, so, that the flexibility of instructions is not high. In addition, in most scenarios, the lengths of the operational data needed by the users are different, so it is necessary to select appropriate fixed-length loading and storage instructions according to the data length, which increases the complexity of programming by the users. Besides, in the scenarios in which a large number of data operations are needed, the users need to additionally maintain the length of the data to be processed and adjust, in time according to the length, the size of data to be loaded and stored next time, which increases the difficulty of programming by the users.

For this reason, a novel data loading and storage instruction solution is needed, which can solve the problems that needed source operands have different lengths and are fragmented in various data processing processes, and it is not conducive to operational data preparation. Software developers can use the data loading and storage instructions flexibly according to the processing requirements of data with different granularities and lengths, and simplify the data preparation and storage processes.

### SUMMARY

In view of this, the present invention provides a novel instruction processing device and a novel instruction processing method, so as to solve or at least alleviate at least one of the above problems.

According to one aspect of the present invention, the present invention provides an instruction processing device, comprising a first register adapted to store a source data address, a second register adapted to store a source data length, a third vector register adapted to store target data, a decoder and an execution unit. The decoder is adapted to receive and decode a data loading instruction. The data loading instruction instructs that the first register serves as a first operand, the second register serves as a second operand, and the third vector register serves as a third operand. The execution unit is coupled to the first register, the second register, the third vector register and the decoder, and executes the decoded data loading instruction, so as to acquire the source data address from the first register, acquire the source data length from the second register, acquire data with a start address being the source data address and a length being based on the source data length from a memory coupled to the instruction processing device, and store the acquired data as the target data in the third vector register.

Optionally, in the instruction processing device according to the present invention, the data loading instruction further instructs an element size, and the execution unit is adapted to calculate a target data length based on the element size and the source data length, so as to acquire data with a length being the target data length as the target data from the memory.

Optionally, in the instruction processing device according to the present invention, the source data length is the number of elements, and the execution unit is adapted to acquire data with the number being the number of elements and a length being the element size as the target data from the memory.

Optionally, in the instruction processing device according to the present invention, the execution unit is adapted to load loading data with a start address being the source data address and a length being a vector size from the memory, and acquire the target data from the loading data, wherein a product of the number of elements multiplied by the element size is not greater than the vector size.

According to another aspect of the present invention, the present invention provides an instruction processing device, comprising a first register adapted to store a target data address, a second register adapted to store a target data length, a third vector register adapted to store source data, a decoder and an execution unit. The decoder is adapted to receive and decode a data storage instruction. The data storage instruction instructs that the first register is a first operand, the second register is a second operand, and the third vector register is a third operand. The execution unit is coupled to the first register, the second register, the third vector register and the decoder, and executes the decoded data storage instruction, so as to acquire the target data address from the first register, acquire the target data length from the second register, acquire the source data from the third vector register, and store data with a length being based on the target data length in the source data at a position with a start address being the target data address in a memory coupled to the instruction processing device.

According to another aspect of the present invention, the present invention provides an instruction processing method, comprising the steps of: receiving and decoding a data loading instruction, the data loading instruction instructing that a first register adapted to store a source data address is a first operand, a second register adapted to store a source data length is a second operand, and a third vector register adapted to store target data is a third operand; acquiring the source data address from the first register; acquiring the source data length from the second register; acquiring data with a start address being the source data address and a length being based on the source data length from a memory; and storing the acquired data as the target data in the third vector register.

According to another aspect of the present invention, the present invention provides an instruction processing method, comprising; receiving and decoding a data storage instruction, the data storage instruction instructing that a first register adapted to store a target data address is a first operand, a second register adapted to store a target data length is a second operand, and a third vector register adapted to store source data is a third operand; acquiring the target data address from the first register; acquiring the target data length from the second register; acquiring the source data from the third vector register; and storing data with a length being based on the target data length in the source data at a position with a start address being the target data address in a memory.

According to another aspect of the present invention, the present invention provides a computing system, comprising a memory and a processor coupled to the memory. The processor comprises a first register adapted to store a source data address, a second register adapted to store a source data length, a third vector register adapted to store target data, a decoder and an execution, unit. The decoder is adapted to receive and decode a data loading instruction. The data loading instruction instructs that the first register serves as a first operand, the second register serves as a second operand, and the third vector register serves as a third operand. The execution unit is coupled to the first register, the second register, the third vector register and the decoder, and executes the decoded data loading, instruction, so as to acquire the source data address from the first register, acquire the source data length from the second register, acquire data with a start address being the source data address and a length being based on the source data length from a memory coupled to the instruction processing device, and store the acquired data as the target data in the third vector register.

According to another aspect of the present invention, the present invention provides a computing system, comprising a memory and a processor coupled to the memory. The processor comprises a first register adapted to store a target data address, a second register adapted to store a target data length, a third vector register adapted to store source data, a decoder and an execution unit. The decoder is adapted to receive and decode a data storage instruction. The data storage instruction instructs that the first register is a first operand, the second register is a second operand, and the third vector register is a third operand. The execution unit is coupled to the first register, the second register, the third vector register and the decoder, and executes the decoded data storage instruction, so as to acquire the target data address from the first register, acquire the target data length from the second register, acquire the source data from the third vector register, and store data with a length being based on the target data length in the source data at a position with a start address being the target data address in a memory coupled to the instruction processing device.

According to another aspect of the present invention, the present invention provides a machine-readable storage medium. The machine-readable storage medium comprises code. When executed, the code causes a machine to execute the instruction processing method according to the present invention.

According to another aspect of the present invention, the present invention provides a system-on-chip, comprising the instruction processing device according to the present invention.

According to the solution of the present invention, a new operand is introduced into the data loading instruction and the data storage instruction. A user can specify the length of data to be loaded and stored in the operand, so that the length of data to be loaded and stored can be set flexibly, and the data loading and storage instructions according to the present invention are variable-length data loading and storage instructions.

In addition, according to the solution of the present invention, if the data loading and storage instructions use registers to store the data length of variable-length loading and storage instructions, the user can set the value in the register according to the needed data length, so as to flexibly perform operational data preparation and storage without performing data combination or splitting a plurality of instructions for execution, thus accelerating the operational data preparation and improving the operational efficiency.

### BRIEF DESCRIPTION OF THE DRAWINGS

In order to achieve the above and related objectives, some descriptive aspects are described herein in combination with the following description with reference to the accompanying drawings. These aspects indicate various ways in which the principles disclosed herein can be practiced, and all aspects and their equivalent aspects are intended to fall within the scope of the subject to be protected. The above and other objectives, features and advantages of the present disclosure will become more apparent by reading the following detailed description with reference to the accompanying drawings. Throughout the present disclosure, the same reference numeral generally represents the same part or element.

FIG. 1 illustrates a schematic diagram of an instruction processing device according to one embodiment of the present invention;

FIG. 2 illustrates a schematic diagram of a register architecture according to one embodiment of the present invention;

FIG. 3 illustrates a schematic diagram of an instruction processing device according to one embodiment of the present invention;

FIG. 4 illustrates a schematic diagram of an instruction processing process according to one embodiment of the present invention;

FIG. 5 illustrates a schematic diagram of an instruction processing method according to one embodiment of the present invention;

FIG. 6 illustrates a schematic diagram of an instruction processing device according to another embodiment of the present invention;

FIG. 7 illustrates a schematic diagram of art instruction processing process according to another embodiment of the present invention;

FIG. 8 illustrates a schematic diagram of an instruction processing method according to another embodiment of the present invention;

FIG. 9A illustrates a schematic diagram of an instruction processing pipeline according to one embodiment of the present invention;

FIG. 9B illustrates a schematic diagram of a processor core architecture according to one embodiment of the present invention;

FIG. 10 illustrates a schematic diagram of a processor according to one embodiment of the present invention;

FIG. 11 illustrates a schematic diagram of a computer system according to one embodiment of the present invention; and

FIG. 12 illustrates a schematic diagram of a system-on-chip (SoC) according to one embodiment of the present invention.

### DETAILED DESCRIPTION

Exemplary embodiments of the present disclosure will be described below in more detail with reference to the accompanying drawings. Although the accompanying drawings show exemplary embodiments of the present disclosure, it should be understood that the present disclosure may be implemented in various forms and should not be limited by the embodiments described herein. Instead, these embodiments are provided so that the present disclosure will be better understood, and the scope of the present disclosure can be fully conveyed to those skilled in the art.

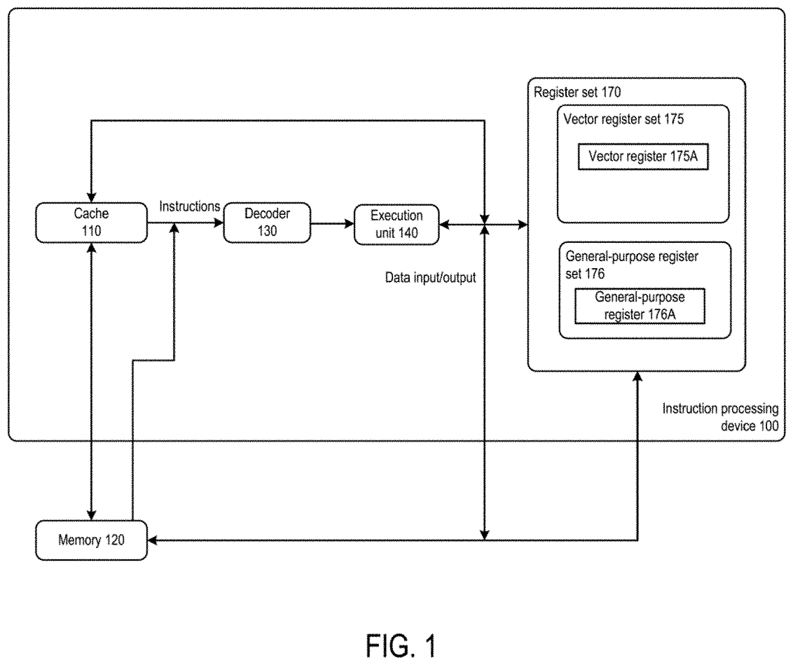

FIG. 1 illustrates a schematic diagram of an instruction processing device 100 according to one embodiment of the present invention. The instruction processing device 100 includes an execution unit 140. The execution unit includes a circuit operable to execute instructions (including data loading instructions and/or data storage instructions according to the present invention). In some embodiments, the instruction processing device 100 may be a processor, a processor core of a multi-core processor, or a processing element in an electronic system.

A decoder 130 receives incoming instructions in the form of high-level machine instructions or macro-instructions, and decodes these instructions to generate low-level micro-operations, micro-code entry points, micro-instructions, or other low-level instructions or control signals. The low-level instructions or control signals can fulfill operations of high-level instructions through low-level (for example, circuit-level or hardware-level) operations. Various mechanisms may be used to implement the decoder 130. Examples of suitable mechanisms include, but are not limited to, micro-codes, lookup tables, hardware implementations, and Programmable Logic Arrays (PLAs). The present invention is not limited to various mechanisms that implement the decoder 130. Any mechanism that can implement the decoder 130 is within the protection scope of the present invention.

The decoder 130 may receive incoming instructions from a cache 110, a memory 120, or other sources. The decoded instructions include one or a plurality of micro-operations, micro-code entry points, micro-instructions, other instructions or other control signals, which reflect the received instructions or are derived from the received instructions. These decoded instructions are transmitted to and executed by the execution unit 140. When executing these instructions, the execution unit 140 receives data input from a register set 170, the cache 110, and/or the memory 120 and generates data output to them.

In one embodiment, the register set 170 includes architectural registers, and the architectural registers are also referred to as registers. Unless otherwise specified or as can be clearly known, terms “architectural registers,” “register set” and “registers” are used to represent registers that are visible to software and/or programmers (for example, visible to software) and/or specified by macro-instructions to identify operands. These registers are different from other non-architectural registers (for example, temporary registers, reorder buffers, retirement registers, etc.) in a given, micro-architecture.

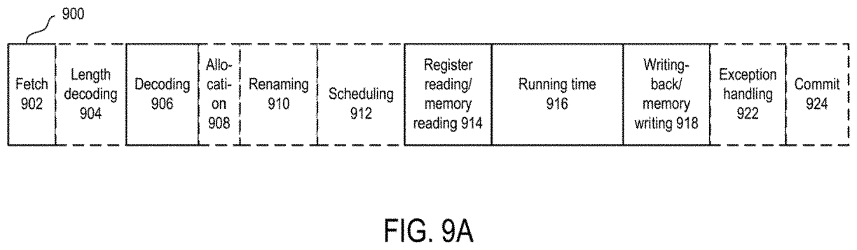

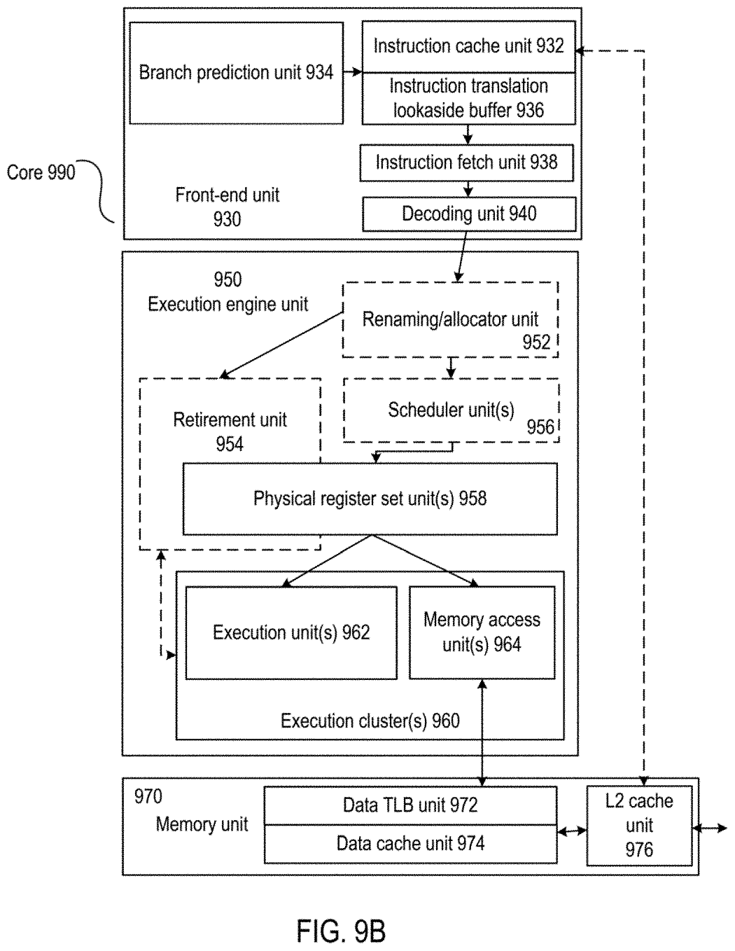

To avoid confusing the description, a relatively simple instruction processing device 100 has been illustrated and described. It should be understood that more than one execution unit may be present in other embodiments. For example, the device 100 may include a plurality of different types of execution units, such as, for example, arithmetic unit. Arithmetic Logic Unit (ALU), integer unit, floating point unit and the like. In other embodiments, the instruction processing device or processor may include a plurality of cores, logic processors or execution engines. A plurality of embodiments of the instruction processing device 100 will be provided later with reference to FIG. 9A to FIG. 12.

According to one embodiment, the register set 170 includes a vector register set 175. The vector register set 175 includes a plurality of vector registers 175A. These vector registers 175A may store operands of data loading instructions and/or data storage instructions. Each vector register 175A may be 512-bit, 256-bit, or 128-bit wide, or different vector widths may be used. The register set 170 may further include a general-purpose register set 176. The general-purpose register set 176 includes a plurality of general-purpose registers 176A. These general-purpose registers 176A may also store operands of data loading instructions and/or data storage instructions.

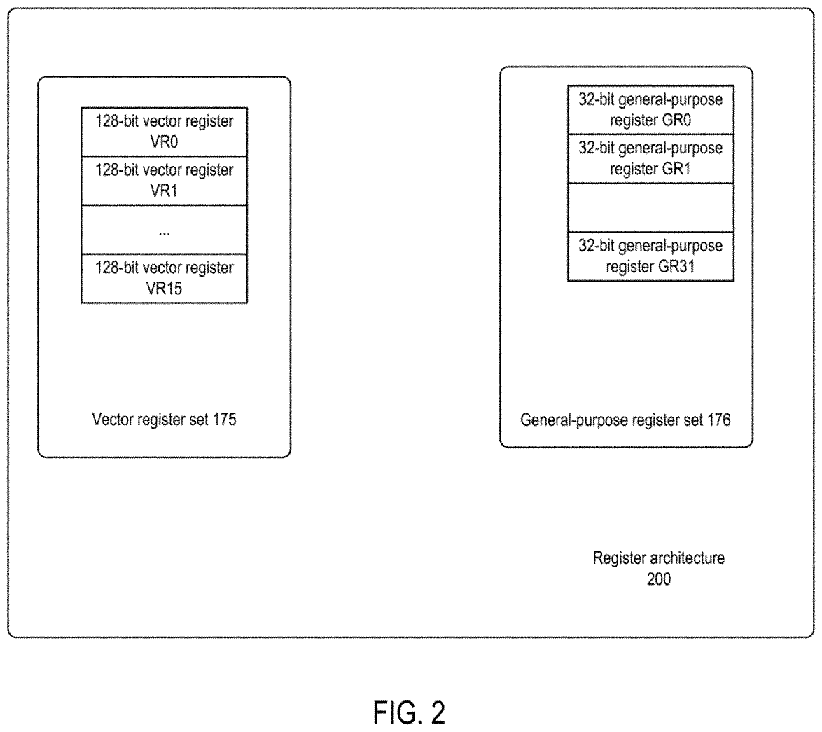

FIG. 2 illustrates a schematic diagram of an underlying register architecture 200 according to one embodiment of the present invention. The register architecture 200 is based on a C-SKY processor, and the processor implements a vector signal processing instruction set. However, it should be understood that different register architectures supporting different register lengths, different register types and/or different numbers of registers may also be used without going beyond the protection scope of the present invention.

As illustrated in FIG. 2, in the register architecture 200, sixteen 128-bit vector registers VR0 [127:0] to VR15 [127:0] and a series of data processing SIMD instructions for these sixteen vector registers are defined. According to the definition of specific instructions, all vector registers may be regarded as a plurality of 8-bit, 16-bit, 32-bit or even 64-bit elements. In addition, in the register architecture 200, thirty-two 32-bit general-purpose registers GR0 [31:0] to GR31 [31:0] are also defined. The general-purpose registers GR0 to GR31 may store some control state values during SIMD instruction processing, and may also store operands during instruction processing. According to one embodiment, the vector register set 175 described with reference to FIG. 1 may adopt one or a plurality of vector registers in the vector registers VR0 to VR15 illustrated in FIG. 2, and the general-purpose register set 176 described with reference to FIG. 1 may also adopt one or a plurality of general-purpose registers in the general-purpose registers GR0-GR31 illustrated in FIG. 2.

In alternative embodiments of the present invention, wider or narrower registers may be used. In addition, in alternative embodiments of the present invention, more, fewer, or different register sets and registers may be used.

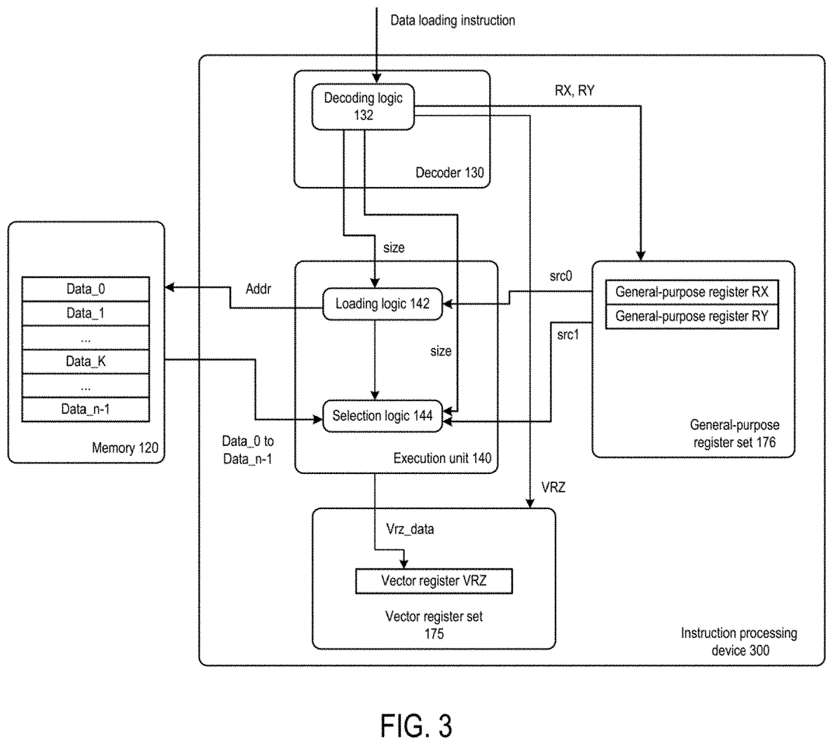

FIG. 3 illustrates a schematic diagram of an instruction processing device 300 according to one embodiment of the present invention. The instruction processing device 300 illustrated in FIG. 3 is a further extension of the instruction processing device 100 illustrated in FIG. 1, and some components are omitted for ease of description. Therefore, the same reference numeral in FIG. 1 is used to indicate the same and/or similar component.

The instruction processing device 300 is adapted to execute data loading instructions. According to one embodiment of the present invention, the data loading instruction has the following format:

VLDX.T VRZ, (RX), RY

RX is a first operand, and specifies a register RX for storing a source data address; RY is a second operand, and specifies a register RY for storing a source data length; VRZ is a third operand, and specifies a vector register VRZ for storing target data. RX and RY are general-purpose registers, and VRZ is a vector register adapted to store vector data.

According to one embodiment of the present invention. T in the instruction VLDX.T specifies an element size, i.e., the bit width of elements in a vector operated by the instruction VLDX.T. When the vector has a 128-bit length, the value of T may be 8-bit, 16-bit, 32-bit, etc. The value of T may be optional. When the value of T is not specified in the instruction VLDX, it can be considered that a default element bit width in the processor, for example, 8-bit, is adopted.

As illustrated in FIG. 3, the decoder 130 includes decoding logic 132. The decoding logic 132 decodes the data loading instruction, so as to determine a vector register VRZ corresponding to VRZ in the vector register set 175, and a general-purpose register RX corresponding to RX and a general-purpose register RY corresponding to RY in the general-purpose register set 176.

Optionally, the decoder 130 also decodes the data loading instruction to obtain the value of T as an immediate operand, or the value of the element size “size” corresponding to the value of T.

The execution unit 140 includes loading logic 142 and selection logic 144.

The loading logic 142 reads the source data address src0 stored in the general-purpose register RX in the general-purpose register set 176, and loads data starting from the source data address src0 and with a predetermined length from the memory 120. According to one embodiment, the loading logic 142 loads data from the memory 120 according to the predetermined length. The predetermined length depends on the width of a data bus that loads data from the memory 120 and/or the width of the vector register VRZ. For example, if the vector register VRZ can store 128-bit vector data, then the predetermined length is 128 bits, i.e., the loading logic 142 loads 128-bit data starting from the address src0 from the memory 120.

The selection logic 144 reads the source data length src1 stored in the general-purpose register RY in the general-purpose register set 176, selects data with a length corresponding to the source data length src1 in the data loaded by the loading logic 142, and then stores the selected data as the target data in the vector register VRZ in the vector register set 175. According to one embodiment of the present invention, the selection logic 144 selects the target data from the least significant bit of the data loaded by the loading logic 142.

Optionally, according to one embodiment of the present invention, when the value of T is specified in the instruction VLDX.T, the selection logic 144 may receive an element size “size” (for example, 8-bit, 16-bit or 32-bit) corresponding to the value of T from the decoding logic 132. Alternatively, when the value of T is not specified in the instruction VLDX, the selection logic 144 may receive a default element size “size” from the decoding logic 132 (when the value of T is not specified, the default may be 8-bit). The selection logic 144 calculates the target data length according to the source data length src1 and the received value of “size,” and selects data with the target data length as the target data from the data loaded by the loading logic 142, so as to store the data in the vector register VRZ.

The vector that can be stored in each vector register in the vector register set 175 may be divided into a plurality of elements according to the element size. For example, when the vector is 128-bit and the element is 8-bit, each vector can be divided into sixteen elements. According to one embodiment of the present invention, the source data length src1 specifies the number K of elements to be loaded (according to one embodiment, the value of K is counted from 0, so that the actual number of elements to be loaded is K+1). The selection logic 144 calculates the target data length according to the value of the number K of elements stored in src1 and the value of the element size “size,” i.e., the target data length is equal to a product of (K+1) *“size” bits. Then the selection logic 144 selects the data with the target, data length as the target data from the data loaded by the loading logic 142, so as to store the data in the vector register VRZ.

Optionally, if the value of “size” is known, then the data loading instruction may be processed in the unit of elements. According to one embodiment of the present invention, the loading logic 142 may also acquire the value of “size” from the decoding logic 132, and determine, according to the vector size and the value of “size,” the number n of elements into which each vector can be divided. Then, the loading logic 142 loads n consecutive pieces of element data Data_0, Data_1, . . . Data_n−1 with a start address being src0 from the memory 120. According, to the value of K stored in src1, the selection logic 144 selects K-+1 pieces of element data Data_0, Data_1, . . . , Data_K in the n pieces of element data and combines the K+1 pieces of element data to form the target data, so as to store the data in the vector register VRZ.

According to one embodiment of the present invention, considering the size of the vector (which is a combination of at most n elements with the size “size”) that can be stored in the vector register VRZ, the value of K is selected to be not greater than the value of an, i.e., a product of (K+1)* “size” is not greater than the vector size.

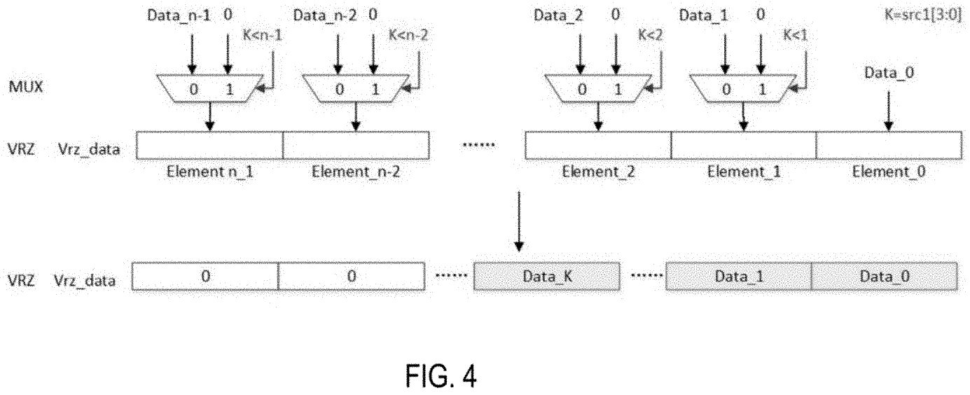

FIG. 4 illustrates an implementation example of the selection logic 144 according to one embodiment of the present invention. In the selection logic 144 illustrated in FIG. 4, the vector size is 128 bits and “size” is 8 bits, so that the value range of K is within 0-15, i.e., the first four bits of src1 may be used as the value of K, K=src1 [3:0].

As illustrated in FIG. 4, for each of the it pieces of element data Data_0, Data_1, . . . , Data_n−1 loaded by the loading logic 142, a corresponding multiplexer MUX is provided (except for Data_0, at least one pieces of element data should be selected by default and be stored in the vector register VRZ); whether to store the value of the element data or the default value 0 at the corresponding element positions Element_0 to Element_n−1 of the vector register is determined according the value of K, and eventually the element data Data_0, Data_1, . . . , Data_K is stored in the vector register VRZ.

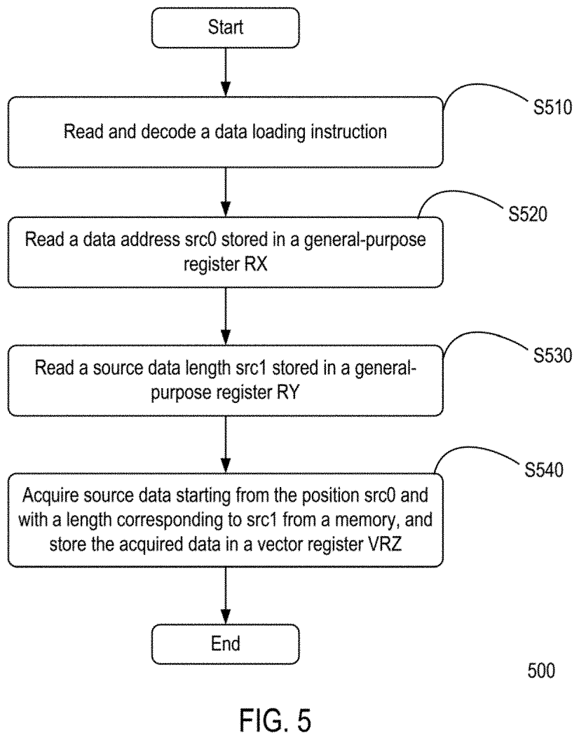

FIG. 5 illustrates a schematic diagram of an instruction processing method according to one embodiment of the present invention. The instruction processing method illustrated in FIG. 5 is applicable to being executed in the instruction processing device, the processor core, the processor computer system, the system-on-chip and the like described with reference to FIG. 1, FIG. 3, FIG. 4 and FIG. 9A to FIG. 12, and is applicable to executing the data loading instruction described above.

As illustrated in FIG. 5, a method 500 starts from step S510, in step S510, a data loading instruction is received and decoded. As described above with reference to FIG. 3, the data loading instruction has the following format:

VLDX.T VRZ, (RX), RY

RX is a first operand, and specifies a register RX for storing a source data address; RY is a second operand, and specifies a register RY for storing a source data length; VR2 is a third operand, and specifies a vector register VRZ for storing target data. RX and RY are general-purpose registers, and VRZ is a vector register adapted to store vector data. According to one embodiment of the present invention, T in the instruction VLDX.T specifies an element size. The value of T may be optional. When the value of T is not specified in the instruction VLDX, it can be considered that a default element bit width in the processor, for example, 8-bit, is adopted.

Then, in step S520, a source data address src0 stored in a general-purpose register RX is read. In step S530, a source data length src1 stored in a general-purpose register RY is read.

Next, in step S540, data with a start address being the source data address src0 and a length being based on the source data length src1 is acquired as target data from a memory 120, and the acquired data is stored in a vector register VRZ.

According to one embodiment of the present invention, the processing in step S540 may include data loading processing and data selection processing. In the data loading processing, data with a predetermined length is acquired from the memory 120. The predetermined length depends on the width of a data bus that loads data from the memory 120 and/or the width of the vector register VRZ. For example, if the vector register VRZ can store 128-bit vector data, then the predetermined length is 128 bits, i.e., 128-bit data starting from the address src0 is loaded from the memory 120. In the data selection processing, data with a length being based on the source data length src1 is acquired as the target data from the data loaded by the data loading processing, so as to store the data in the vector register VRZ.

Optionally, according to one embodiment of the present invention, when the data loading instruction VLDX.T is decoded in step S510, decoding is also performed to obtain the value of an element size “size” corresponding to the value of an immediate operand T. In step S540, the target data length may be calculated according to the source data length src1 and the received value of “size,” so as to acquire data with a start address being src0 and a length being the target data length as the target data from the memory 120, so as to store the acquired data in the vector register VRZ.

The vector that can be stored in each vector register in the vector register set 175 may he divided into a plurality of elements according to the element size. For example, when the vector is 128-bit and the element is 8-bit, each vector can be divided into sixteen elements. According to one embodiment of the present invention, the source data length src1 specifies the number K of elements to be loaded (according to one embodiment, the value of K is counted from 0, so that the actual number of elements to be loaded is K+1). In step S540, the target data length is calculated according, to the value of the number K of elements stored in src1 and the value of the element size “size,” i.e., the target data length is equal to a product of (K+1) * “size” bits. Then the data with the target data length is selected as the target data from the data loaded by the data loading processing, so as to store the data in the vector register VRZ.

Optionally, if the value of “size” is known, then the processing in step S540 may be performed in the unit of elements. According to one embodiment of the present invention, in the data loading processing in step S540, the number n of elements into which each vector can be divided is determined according to the vector size and the value of “size,” and then n consecutive pieces of element data Data_0, Data_1, . . . , Data_n−1 with a start address being src0 are loaded from the memory 120. In the data selection processing in step S540, according to the value of K stored in src1, K+1 pieces of element data Data_0, Data_1, . . . , Data_K in n pieces of element data are selected and the K+1 pieces of element data are combined to form the target data, so as to store the data in the vector register VRZ.

According to one embodiment of the present invention, considering the size of the vector (which is a combination of at most n elements with the size “size”) that can be stored in the vector register VRZ, the value of K is selected to be not greater than the value of n, i.e., a product of (K+1) * “size” is not greater than the vector size.

The processing in step S540 is basically the same as the processing performed by the loading logic 142 and the selection logic 144 in the execution unit 140 described above with reference to FIG. 3, and therefore details will not be described herein again.

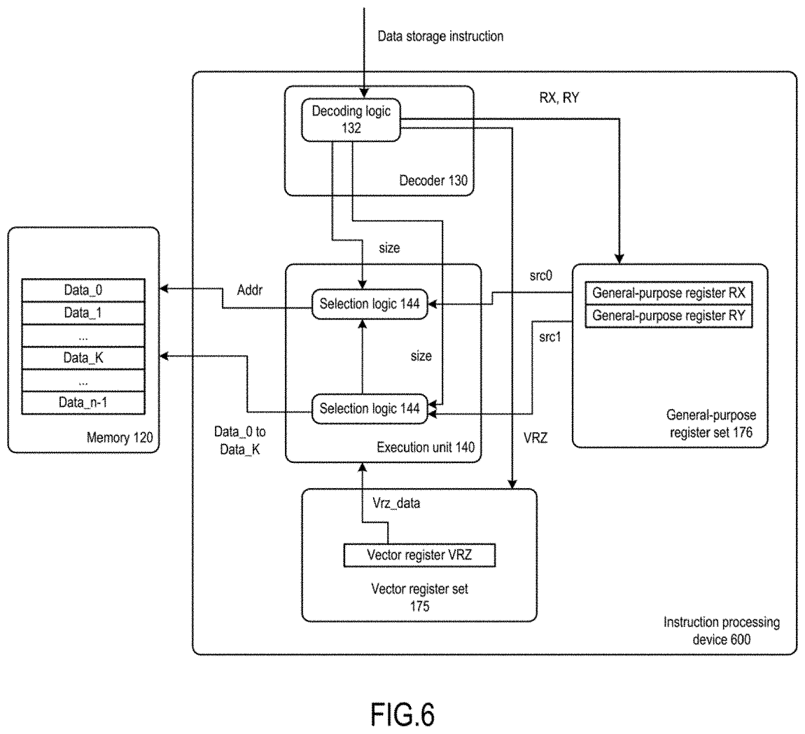

FIG. 6 illustrates a schematic diagram of an instruction processing device 600 according to one embodiment of the present invention. The instruction processing device 600 illustrated in FIG. 6 is a further extension of the instruction processing device 100 illustrated in FIG. 1, and some components are omitted for ease of description. Therefore, the same reference numeral in FIG. 1 is used to indicate the same and/or similar component.

The instruction processing device 600 is adapted to execute data storage instructions. According to one embodiment of the present invention, the data storage instruction has the following format:

VSTX,T VRZ, (RX), RY

RX is a first operand, and specifies a register RX for storing a target data address; RY is a second operand, and specifies a register RY for storing a target data length; VRZ is a third operand, and specifies a vector register VRZ for storing source data, RX and RY are general-purpose registers; VRZ is a vector register adapted to store vector data, and part or all of the vector data may be stored in the aleatory 120 by using a data storage instruction VSTX.

According to one embodiment of the present invention, T in the instruction VSTX.T specifies an element size, i.e., the bit width of elements in a vector operated by the instruction VSTX.T. When the vector has a 128-bit length, the value of T may be 8-bit, 16-bit, 32-bit, etc. The value of T may be optional. When the value of T is not specified in the instruction VSTX, it can be considered that a default element bit width in the processor, for example, 8-bit, is adopted.

As illustrated in FIG. 6, the decoder 130 includes decoding logic 132. The decoding logic 132 decodes the data storage instruction, so as to determine a vector register VRZ corresponding to VRZ in the vector register set 175, and a general-purpose register RX corresponding to RX and a general-purpose register RY corresponding to RY in the general-purpose register set 176.

Optionally, the decoder 130 also decodes the data storage instruction to obtain the value of T as an immediate operand, or the value of the element size “size” corresponding to the value of T.

The execution unit 140 includes selection logic 142 and storage logic 144.

The selection logic 142 acquires the target data length src1 stored in the general-purpose register RY, and acquires the vector data Vrz_data stored in the vector register VRZ. Then, the selection logic 144 selects target data with a length corresponding to the target data length src1 from the acquired vector data Vrz_data, and transmits the data to the storage logic 144. According to one embodiment of the present invention, the selection logic 142 selects the target data from the least significant bit of the vector data Vrz_data.

The storage logic 144 reads the target data address src0 stored in the general-purpose register RX, and writes the target data received from the selection logic 142 to the target data address src0 of the memory 120.

Optionally, according to one embodiment of the present invention, when the value of specified in the instruction VSTX.T, the selection logic 142 may receive an element size “size” (for example, 8-bit, 16-bit or 32-bit) corresponding to the value of T from the decoding logic 132. Alternatively, when the value of T is not specified in the instruction VSTX, the selection logic 142 may receive a default element size “size” from the decoding logic 132 (when the value of T is not specified, the default may be 8-bit). The selection logic 142 calculates the target data length according to the source data length src1 and the received value of “size,” and selects data with the target data length as the target data from the vector data Vrz_data acquired by the vector register VRZ, so as to transmit the data to the storage logic 144 and store the data in the memory 120.

The vector that can be stored in each vector register in the vector register set 175 may be divided into a plurality of elements according to the element size. For example, when the vector is 128-bit and the element is 8-bit, each vector can be divided into sixteen elements. According to one embodiment of the present invention, the target data length src1 specifies the number K of elements to be stored (according to one embodiment, the value of K is counted from 0, so that the actual number of elements to be stored is K+1). The selection logic 142 calculates the target data length according to the value of the number K of elements stored in src1 and the value of the element size “size,” i.e., the target data length is equal to a product of (K+1) “size” bits. Then, the selection logic 142 selects data with the target data length as the target data from the vector data Vrz_data acquired by the vector register VRZ and transmits the data to the storage logic 144, so as to store the data in the memory 120.

Optionally, if the value of “size” is known, then the data storage instruction may be processed in the unit of elements. According to one embodiment of the present invention, the selection logic 142 divides the vector data Vrz_data read from the vector register VRZ into n pieces of element data Data_0, Data 1, . . . , Data_n−1. According to the value of K stored in src1, the selection logic 142 selects K+1 pieces of element data Data_0, Data_1, . . . , Data_K from the n pieces of element data. The storage logic 142 may, also acquire the value of “size” from the decoding logic 132, and according to the value of “size,” store the K−1 pieces of element data Data_0, Data_1, . . . , Data_K respectively at the target address src0 in the memory 120.

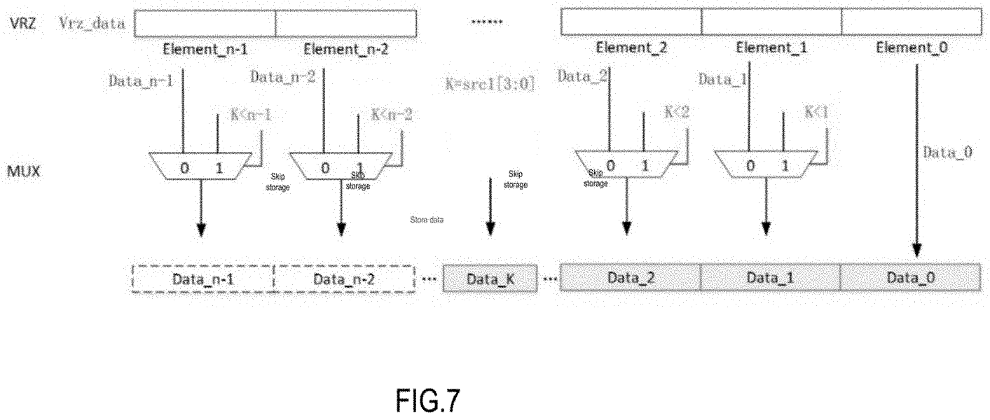

FIG. 7 illustrates an implementation example of the selection logic 142 according to one embodiment of the present invention. In the selection logic 142 illustrated in FIG. 7, the vector size is 128 bits and “size” is 8 bits, so that the value range of K is within 0-15, i.e., the first four bits of src1 may be used as the value of K, K=src1 [3:0].

As illustrated in FIG. 7, for the vector data Vrz_data read from the, vector register VRZ, n pieces of element data Data 0, Data 1, . . . , Data_n−1 are respectively acquired from n positions Element_0, Element_1, . . . , Element_n of the vector data; for each pieces of element data in the n pieces of element data, a corresponding multiplexer MUX is provided (except for Data_0, at least one pieces of element data should be selected by default and be stored in the memory); whether to select the element data is determined according to the value of K, and eventually a plurality of pieces of element data Data_0, Data_1, . . . , Data_K are acquired and thus stored in the memory 120 by the storage logic 144.

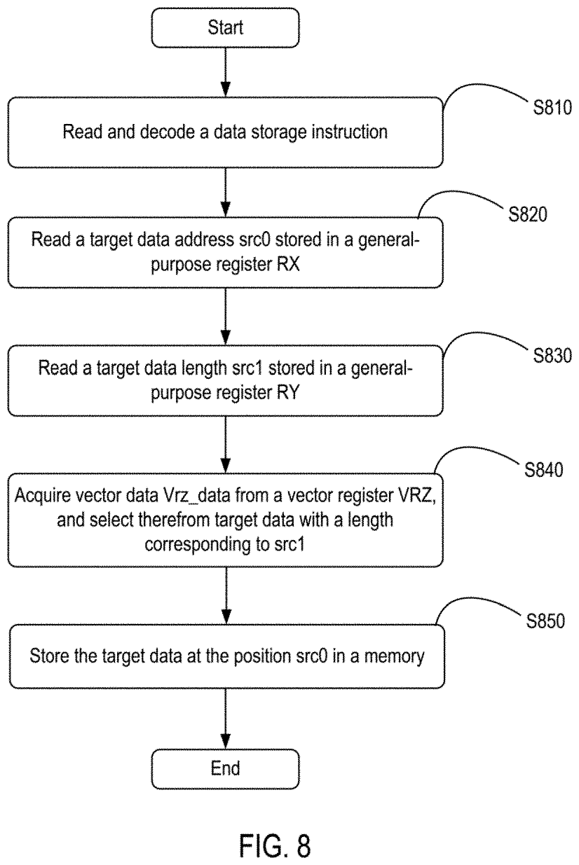

FIG. 8 illustrates a schematic diagram of an instruction processing method 800 according to one embodiment of the present invention. The instruction processing method illustrated in FIG. 8 is applicable to being executed in the instruction processing device, the processor core, the processor computer system, the system-on-chip and the like described with reference to FIG. 1, 3, FIG. 4 and FIG. 9A to FIG. 12, and is applicable to executing the data storage instruction described above.

As illustrated in FIG. 8, a method 800 starts from step S810. In step S810, a data storage instruction is received, and decoded. As described above with reference to FIG. 6, the data storage instruction has the following format:

VSTX.T VRZ, (RX), RY

RX is a first operand, and specifies a register RX for storing a target data address src0; RY is a second operand, and specifies a register RY for storing a target data length src1; VRZ is a third operand and specifies a vector register VRZ for storing source data Vrz_data, RX and RY are general-purpose registers; VRZ is a vector register adapted to store vector data, and part or all of the vector data, may be stored in the memory 120 by using a data storage instruction VSTX. According to one embodiment of the present invention, T in the instruction VSTX.T specifies an element size. The value of T may be optional. When the value of T is not specified in the instruction VSTX, it can be considered that a default element bit width in the processor, for example, 8-bit, is adopted.

Then, in step S820, a target data address src0 stored in a general-purpose register RX is read. In step S830, a target data length src1 stored in a general-purpose register RY is read.

Then, in step S840, vector data Vrz_data is acquired from the vector register VRZ, and data with a length being based on src1 is selected as target data from the vector data Vrz_data. Thus, in step S850, the data selected in step S840 is stored at the target data address src0 in the memory 120.

Optionally, according to one embodiment of the present invention, in step S840, when the value of T is specified in the instruction VSTX.T, an element size “size” (for example, 8-bit, 16-bit or 32-bit) corresponding to the value of T may be received. Alternatively, when the value of T is not specified in the instruction VS TX, a default element size “size” may be received (when the value of T is not specified, the default may be 8-bit). Then, in step S840, the target data length is calculated according to the source data length src1 and the received value of “size,” and data with the target data length is selected as the target data from the vector data Vrz_data acquired by the vector register VRZ.

The vector that can be stored in each vector register in the vector register set 175 may be divided into a plurality of elements according to the element size. For example, when the vector is 128-bit and the clement is 8-bit, each vector can be divided into sixteen elements. According to one embodiment of the present invention, the target data length src1 specifies the number K of elements to be stored (according to one embodiment, the value of K is counted from 0, so that the actual number of elements to be stored is K+1). In step S840, the target data length is calculated according to the value of the number K of elements stored in src1 and the value of the element size “size,” i.e, the target data length is equal to a product of (K+1) * “size” bits. Then, data with the target data length is selected as the target data from the vector data Vrz_data acquired by the vector register VRZ.

Optionally, if the value of “size” is known, then the data storage instruction may be processed in the unit of elements. According to one embodiment of the present invention, the vector data Vrz_data read from the vector register VRZ is divided into n pieces of element data Data_0, Data_1, . . . , Data_n−1, and K+1 pieces of element data Data_0, Data_1, . . . , Data_K in the n pieces of element data are selected according to the value of K stored in src1. In step S850, according to the value of “size,” the K+1 pieces of element data Data_0, Data_1, . . . , Data_K may be respectively stored at the target address src0 in the memory 120.

The processing in step S840 and step S850 is basically the same as the processing performed by the selection logic 142 and the storage logic 144 in the execution unit 140 described above with reference to FIG. 6, and therefore details will not be described herein again.

As described above, the instruction processing device according to the present invention may be implemented as a processor core, and the instruction processing method may be executed in the processor core. The processor core may be implemented in different ways in different processors. For example, the processor core may be implemented as a general-purpose in-order core for general-purpose computing, a high-performance general-purpose out-of-order core for general-purpose computing, and a special-purpose core for graphics and/or scientific (throughput) computing. The processor may be implemented as a Central Processing Unit (CPU) and/or a coprocessor. The CPU may include one or a plurality of general-purpose in-order cores and/or one or a plurality of general-purpose out-of-order cores, and the coprocessor may include one or a plurality of special-purpose cores. A combination of such different processors may lead to different computer system architectures. In one computer system architecture, the coprocessor is located on a chip separate from the CPU. In another computer system architecture, the coprocessor is located in the same package as the CPU but on a separate die. In another computer system architecture, the coprocessor is located on the same die as the CPU (in this case, such a coprocessor is sometimes referred to as special-purpose logic such as integrated graphics and/or scientific (throughput) logic or referred to as a special-purpose core). In another computer system architecture referred to as a system-on-chip, the described CPU (sometimes referred to as an application core or application processor), the coprocessor described above and additional functions may be included on the same die. An exemplary core architecture, processor, and computer architecture will be described later with reference to FIG. 9A to FIG. 12.

FIG. 9A illustrates a schematic diagram of an instruction processing pipeline according to one embodiment of the present invention, where the pipeline includes an in-order pipeline and an out-of-order issue/execution pipeline. FIG. 9B illustrates a schematic diagram of a processor core architecture according to one embodiment of the present invention, where the processor core architecture includes an in-order architecture core and an out-of-order issue/execution architecture core related to register renaming. In FIG. 9A and FIG. 9B, the in-order pipeline and the in-order core are illustrated in a solid line box, while the out-of-order issue/execution pipeline and core are illustrated as optional additional items in a dashed line box.

As illustrated in FIG. 9A, a processor pipeline 900 includes an fetch stage 902, a length decoding stage 904, a decoding stage 906 an allocation stage 908, a renaming stage 910, a scheduling (also known as dispatching or issue) stage 912, a register reading/memory reading stage 914, an execution stage 916, a writing-back/memory writing stage 918, an exception handling stage 922 and a commit stage 924.

As illustrated in FIG. 9B, a processor core 990 includes an execution engine unit 950 and a front-end unit 930 coupled to the execution engine unit 950. Both the execution engine unit 950 and the front-end unit 930 are coupled to a memory unit 970. A core 990 may be a Reduced Instruction Set Computing (RISC) core, a Complex Instruction Set Computer (CISC), a Very Long Instruction Word (VLIW) core or a hybrid or alternative core type. Optionally, the core 990 may be a special-purpose core, such as, for example, a network or communication core, a compression engine, a coprocessor core, a General-Purpose Graphics Processing Unit (GPGPU) core or a Graphics Processing Unit (GPU) core.

The front-end unit 930 includes a branch prediction unit 934, an instruction cache unit 932 coupled to the branch prediction unit 934, an instruction Translation Look side Buffer (TLB) 936 coupled to the instruction cache unit 932, an instruction fetch unit 938 coupled to the instruction translation lookaside buffer 936, and a decoding unit 940 coupled to the instruction fetch unit 938. The decoding unit (or decoder) 940 may decode an instruction and generate one or a plurality of micro-operations, micro-code entry points, micro-instructions, other instructions, or other control signals decoded from, or otherwise reflecting or derived from the original instruction, as an output. The decoding unit 940 may be implemented by adopting various mechanisms, including but not limited to lookup table, hardware implementation, Programmable Logic Array (PLA), micro-code Read-Only Memory (ROM), etc. In one embodiment, the core 990 includes a micro-code ROM or other media that store micro-codes of certain macro-instructions (for example, in the decoding unit 940 or otherwise in the front-end unit 930). The decoding unit 940 is coupled to a renaming/allocator unit 952 in the execution engine unit 950.

The execution engine unit 950 includes the, renaming/allocator unit 952. The renaming/allocator unit 952 is coupled to a retirement unit 954 and one or a plurality of scheduler units 956. The scheduler unit 956 represents any number of different schedulers, including reservation stations, central instruction windows, etc. The scheduler unit 956 is coupled to each physical register set unit 958. Each physical register set unit 958 represents one or a plurality of physical register sets. Different physical register sets store one or a plurality of different types of data, such as scalar integers, scalar floating points, packed integer, packed floating points, vector integers, vector floating points, states d for example, an instruction pointer being the address of the next instruction to be executed), etc. In one embodiment, the physical register set unit 958 includes a vector register unit, a write mask register unit, and a scalar register unit. These register units can provide architectural vector registers, vector mask registers, and general-purpose registers. The physical register set unit 958 is covered by the retirement unit 954 to show various ways in which register renaming and out-of-order execution can be implemented (for example, using a reorder buffer and a retirement register set; using a future file, a history butler and a retirement register set; using a register map and a register pool, etc.). The retirement unit 954 and the physical register set unit 958 are coupled to an execution cluster 960. The execution cluster 960 includes one or a plurality of execution units 962 and one or a plurality of memory access units 964. The execution unit 962 may execute various operations (for example, shifting, addition, subtraction, and multiplication), and execute operations to various types of data (for example, scalar floating points, packed integers, packed floating points, vector integers and vector floating points). Although some embodiments may include a plurality of execution units dedicated to a particular function or set of functions, other embodiments may include only one execution unit or a plurality of execution units that execute all functions. In some embodiments, because separate pipelines (for example, scalar integer pipelines, scalar floating point/packed integer/packed floating point/vector integer/vector floating point pipelines, and/or memory access pipelines that each have their own scheduler unit, physical register set unit and/or execution cluster) are created for some types of data/operations, more than one scheduler unit 956, physical register set unit 958 and execution cluster 960 may be present. It should also be understood that, in the case of separate pipelines, one or a plurality of these pipelines may be out-of-order issue/execution pipelines, and the rest may be in-order issue/execution pipelines.

The memory access unit 964 is coupled to a memory unit 970. The memory unit 970 includes a data TLB unit 972, a data cache unit 974 coupled to the data TLD unit 972, and a level 2 (L2) cache unit 976 coupled to the data cache unit 974. In one exemplary embodiment, the memory access unit 964 may include a loading unit, an address storage unit and a data storage unit, each of which is coupled to the data TLB unit 972 in the memory unit 970. The instruction cache unit 934 may also be coupled to the, level 2, (L2) cache unit 976 in the memory unit 970. The L2 cache unit 976 is coupled to the cache at one or a plurality of other levels, and is eventually coupled to a main memory.

As an example, the core architecture described above with reference to FIG. 9B may implement the pipeline 900 described above with reference to FIG. 9A in the following way. 1) the instruction fetch unit 938 executes the fetch and length decoding stages 902 and 904; 2) the decoding unit 940 executes the decoding stage 906; 3) the renaming/allocator unit 952 executes the allocation stage 908 and the renaming stage 910; 4) the scheduler unit 956 executes the scheduling stage 912; 5) the physical register set unit 958 and the memory unit 970 execute the register reading/memory reading stage 914; the execution cluster 960 executes the execution stage 916; 6) the memory unit 970 and the physical register set unit 958 execute the writing-back/memory writing stage 918; 7) each unit may be involved in the exception handling stage 922; and 8) the retirement unit 954 and the physical register set unit 958 execute the commit stage 924.

The core 990 can support one or a plurality of instruction sets (for example, x86 instruction set (with some extensions added with a newer version); MIPS instruction sets of MIPS Technologies company; instruction sets of ARM Holdings (with optional additional extensions such as NEON)), which include the instructions described herein. It should be understood that the core can support multi-threading (executing two or more parallel sets of operations or threads) and can accomplish the multi-threading in a variety of ways, including time division multi-threading. simultaneous multi-threading (in which a single physical core provides a logical core for each of threads subjected to the simultaneous multi-threading performed by the physical core), or a combination thereof (for example, time division fetching and decoding, and then simultaneous multithreading by using, for example, a hyper-threading technology).

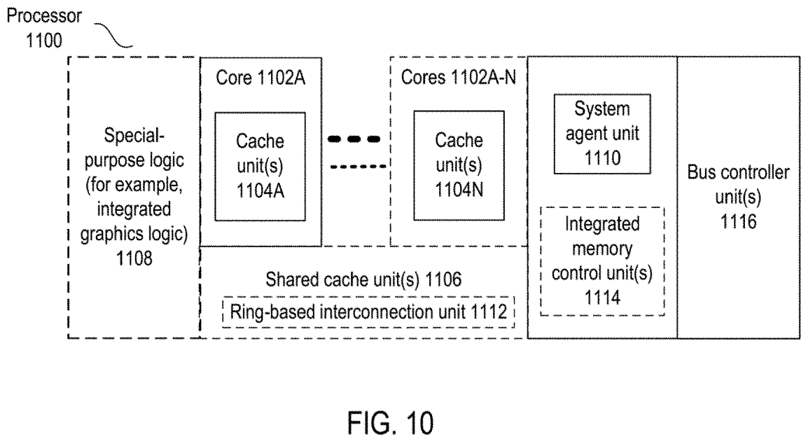

FIG. 10 illustrates a schematic diagram of a processor 1100 according to one embodiment of the present invention. As illustrated by a solid line box in FIG. 10, according to one embodiment, the processor 1100 includes a single core 1102A, a system agent unit 1110 and a bus controller unit 1116. As illustrated in a dashed line box in FIG. 10, according to another embodiment of the present invention, the processor 1100 may also include a plurality of cores 1102A-N, an integrated memory controller unit 1114 in the system agent unit 1110, and special-purpose logic 1108.

According to one embodiment, the processor 1100 may be implemented as a Central Processing Unit (CPU). The special-purpose logic 1108 is integrated graphics and/or scientific (throughput) logic (which may include one or a plurality of cores), and the cores 1102A-N are one or a plurality of general-purpose cores (for example, general-purpose in-order cores, general purpose out-of-order cores, or a combination thereof). According to another embodiment, the processor 1100 may be implemented as a coprocessor, and the cores 1102A-N are a plurality of special-purpose cores for graphics and/or scientific (throughput). According to another embodiment, the processor 1100 may be implemented as a coprocessor, and the cores 1102A-N are a plurality of general-purpose in-order cores. Therefore, the processor 1100 may be a general-purpose processor, a coprocessor or a special-purpose processor, such as, for example, a network or communication processor, a compression engine, a graphics processing unit, a General-Purpose Graphics Processing Unit (GPGPU), a high-throughput Many Integrated Core (MC) coprocessor (including thirty or more cores), or an embedded processor. The processor 1100 can be implemented on one or a plurality of chips. The processor 1100 may be part of one or a plurality of substrates, and/or may be implemented on one or a plurality of substrates by using any one of a plurality of processing technologies, such as, for example, BiCMOS, CMOS or NMOS,

The memory hierarchy includes one or a plurality of levels of caches in each core, one or a plurality of shared cache units 1106, and an external memory (not shown) coupled to the integrated memory controller unit 1114. The shared cache unit 1106 may include one or a plurality of caches at intermediate levels, such as caches at level 2 (L2), level 3 (L3), level 4 (L4) or other levels, a Last Level Cache (LLC), and/or a combination thereof. Although in one embodiment, a ring-based interconnection unit 1112 interconnects the integrated graphics logic 1108, the shared cache unit 1106 and the system agent unit 1110/integrated memory controller unit 1114, the present invention is not limited thereto, and any number of well-known technologies may be used to interconnect these units.

The system agent unit 1110 includes components that coordinate and operate the cores 1102A-N. The system agent unit 1110 may include, for example, a Power Control Unit (PCU) and a display unit. The PCU may include logic and components required for adjusting the power states of the cores 1102A-N and the integrated graphics logic 1108. The display unit is used to drive one or a plurality of externally connected displays.

The cores 1102A-N may have a core architecture described above with reference to FIG. 9A and FIG. 9B, and may be homogenous or heterogeneous in terms of the architecture instruction set. That is, two or more of these cores 1102A-N may be capable of executing the same instruction set, while other cores may be capable of executing only subsets of this instruction set or a different instruction set.

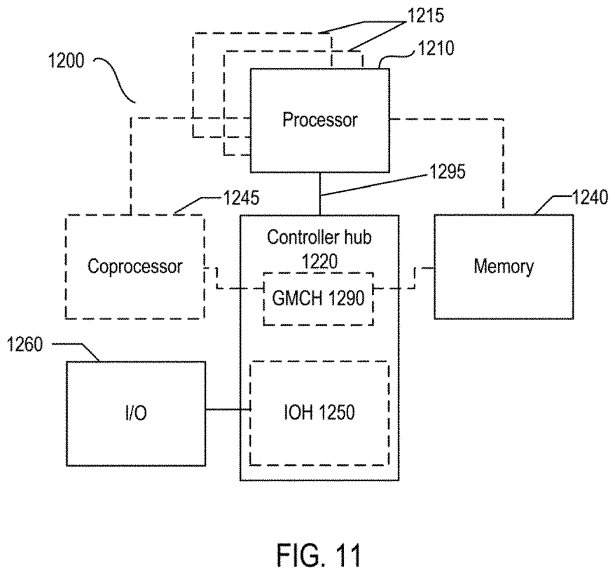

FIG. 11 illustrates a schematic diagram of a computer system 1200 according to, one embodiment of the present invention. The computer system 1200 illustrated in FIG. 11 may be applied to laptops, desktop computers, hand-held PCs, personal digital assistants, engineering workstations, servers, network devices, network hubs, switches, embedded processors, Digital Signal Processors (DSPs), graphics devices, video game devices, set-top boxes, microcontrollers, cellular phones, portable media players, hand-held devices and various other electronic devices. The present invention is not limited thereto, and all systems capable of incorporating the processors and/or other execution logic disclosed in the description are included in the protection scope of the present invention.

As illustrated in FIG. 11, the system 1200 may include one or a plurality of processors 1210, 1215. These processors are coupled to a controller hub 1220. In one embodiment, the controller hub 1220 includes a Graphics Memory Controller Hub (GMCH) 1290 and an Input/Output Hub (IOH) 1250 (which may be located on separate chips). The GM MCU 1290 includes a memory controller and a graphics controller coupled to a memory 1240 and a coprocessor 1245. The IOH 1250 couples an Input/Output (110) device 1260 to the GMCH 1290. Alternatively, the memory controller and the graphics controller are integrated in the processor, so that the memory 1240 and the coprocessor 1245 are directly coupled to the processor 1210. In this case, the controller hub 1220 includes only the IOU 1250.

The optional nature of the additional processor 1215 is denoted by dashed lines in FIG. 11. Each processor 1210, 1215 may include one or a plurality of the processor cores described herein, and may be a certain version of the processor 1100.

The memory 1240 may be, for example, a Dynamic Random Access Memory (DRAM), a Phase Change Memory (PCM), or a combination thereof. In at least one embodiment, the controller hub 1220 communicates with the processors 1210, 1215 via a multi-drop bus such as a Front Side Bus (FSB), a point-to-point interface such as a Quick Path Interconnect (QPI), or a similar connection 1295.

In one embodiment, the coprocessor 1245 is a special-purpose processor, such as, for example, a high-throughput MIC processor, a network or communication processor, a compression engine, a graphics processing unit, a GPGPU or an embedded processor. In one embodiment, the controller hub 1220 may include an integrated graphics accelerator.

In one embodiment, the processor 1210 executes instructions that control a general type of data processing operations. What are embedded in these instructions may be coprocessor instructions. The processor 1210 identifies, for example, these coprocessor instructions of types that should be executed by the attached coprocessor 1245. Therefore, the processor 1210 issues these coprocessor instructions (or control signals representing coprocessor instructions) to the coprocessor 1245 over a coprocessor bus or other interconnects. The coprocessor 1245 receives and executes the received coprocessor instructions.

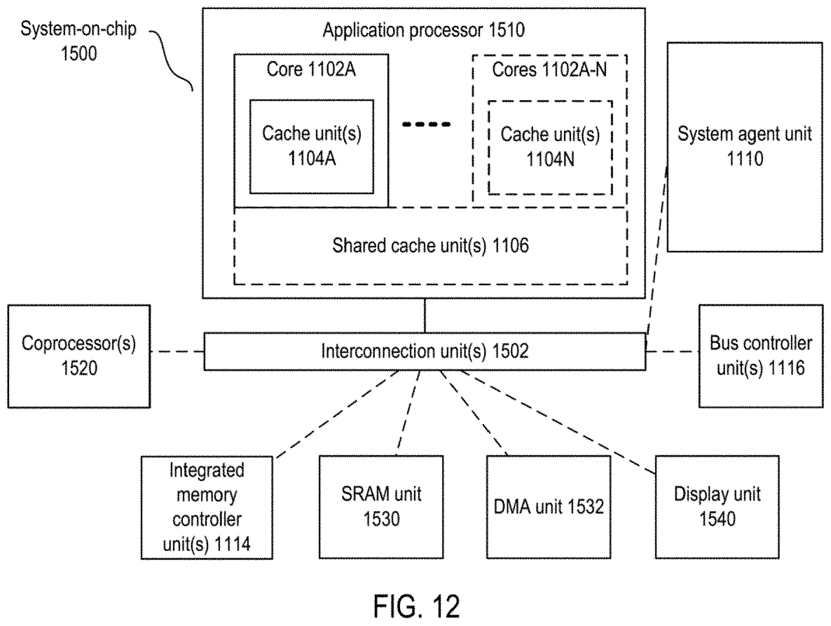

FIG. 12 illustrates a schematic diagram of a system-on-chip (SoC.) 1500 according to one embodiment of the present invention. The system-on-chip illustrated in FIG. 12 includes the processor 1100 illustrated in FIG. 74, so that components similar to those in FIG. 7 are denoted by the same reference numerals. As illustrated in FIG. 12, an interconnection unit 1502 is coupled to an application processor 1510, a system agent unit 1110, a bus controller unit 1116, an integrated memory controller unit 1114, one or a plurality of coprocessors 1520, a Static Random Access Memory (SRAM) unit 1530, a Direct Memory Access (DMA) unit 1532, and a display unit 1540 for being coupled to one or a plurality of external displays. The application processor 1510 includes a set of one or a plurality of cores 1102A-N, and a shared cache unit 110. The coprocessor 1520 includes an integrated graphics logic, an image processor, an audio processor and a video processor. In one embodiment, the coprocessor 1520 includes a special-purpose processor, such as, for example, a network or communication processor, a. compression engine, a GPGPU, a high-throughput MIC processor or an embedded processor.

All embodiments of the mechanisms disclosed herein may be implemented in hardware, software, firmware, or a combination thereof. The embodiments of the present invention may be implemented as computer programs or program codes executed on a programmable system. The programmable system includes at least one processor, a storage system (including volatile and non-volatile memory an for storage elements), at least one input device, and at least one output device.

It should be understood that, in order to simplify the present disclosure and to facilitate understanding of one or a plurality of aspects of the present invention, in the above description of the exemplary embodiments of the present invention, various features of the present invention arc sometimes grouped together into a single embodiment, diagram, or description thereof. However, the disclosed method should not be interpreted to reflect the intention that the claimed invention claims more features than those clearly recited in each claim. More precisely, as reflected in the following claims, inventive aspects lie in less than all features of a single foregoing disclosed embodiment. Thus, the claims following the detailed description are hereby clearly incorporated into this detailed description, with each claim standing on its own as a separate embodiment of the present invention.

One skilled in the art should understand that the modules, units or components of the devices in the embodiments disclosed herein may be disposed in the devices described in the embodiments, or alternatively positioned in one or a plurality of devices different from the devices in the embodiments. The modules described in the embodiments may be combined into one module or may be divided into a plurality of submodules.

One skilled in the art can understand that the modules in the devices in the embodiments may be adaptively changed and disposed in one or a plurality of devices different from the devices in the embodiments. The modules, units or components in the embodiments may be combined into one module, unit or component, and in addition, they may be divided into a plurality of submodules, subunits or subcomponents. All features disclosed in the description (including the accompanying claims, abstract and drawings), and all processes or units of any methods or devices so disclosed, may be combined in any way, except that at least some of such features and/or processes or units are mutually exclusive. Unless otherwise clearly stated, each feature disclosed in the description (including the accompanying, claims, abstract and drawings) may be replaced by alternative features serving the same, equivalent or similar purpose.

In addition, those skilled in the art can understand that, although some of the embodiments described herein include some but not other features included in other embodiments, combinations of features of different embodiments are meant to be within the scope of the present invention and form different embodiments. For example, in the following claims, any one of the claimed embodiments may be used in any combination.

In addition, some of the embodiments are described herein as a combination of methods or method elements that can be implemented by a processor of a computer system or by other devices that execute the functions. Therefore, a processor having necessary instructions for implementing the methods or method elements forms a device for implementing the methods or method elements. In addition, the elements described in the device embodiments are examples of devices for implementing functions executed by elements for the purpose of implementing the present invention.

As used herein, unless otherwise specified, the use of ordinals “first,” “second,” “third” and the like to describe common objects merely represents different examples involving similar objects, and is not intended to imply that such described objects must have a given order in time, space, sorting or any other aspects.

Although the present invention has been described according to a limited number of embodiments, benefiting from the above description, those skilled in the art can understand that other embodiments may be conceived of within the scope of the present invention described thereby. In addition, it should be noted that the language used in the description is mainly selected for readability and teaching purposes, rather than for interpreting or defining the subject of the present invention. Therefore, many modifications and variations made without departing from the scope and spirit of the appended claims are apparent to those ordinarily skilled in the art. In regard to the scope of the present invention, the disclosure of the present invention is descriptive rather than restrictive, and the scope of the present invention should be defined by the appended claims.

1. An instruction processing device, comprising:
a first register adapted to store a source data address;
a second register adapted to store a source data length;
a third vector register adapted to store target data;
a decoder adapted to receive and decode a data loading instruction, the data loading instruction instructing that:
the first register serves as a first operand,
the second register serves as a second operand and
the third vector register serves as a third operand; and
an execution unit coupled to the first register, the second register, the third vector register and the decoder, and executing the decoded data loading instruction, so as to acquire the source data address from the fast register, acquire the some data length from the second register, acquire data with a start address being the source data address aid a length being based on the source data length from a memory coupled to the instruction processing device, and store the acquired data as the target data in the third vector register.

2. The instruction processing device according to claim 1, wherein the data loading instruction further instructs an element size, and the execution unit is adapted to calculate a target data length based on the element size and the source data length, so as to acquire data with a length being the target data length as the target data from the memory.

3. The instruction processing device according to claim 2, wherein the source data length is a number of elements, and the execution unit is adapted to acquire the data with a number being the number of elements and the length being the element size as the target data from the memory.

4. The instruction processing device according to claim 3, wherein the execution unit is adapted to load loading data with the start address being the source data address and the length being a vector size from the memory, and acquire the target data from the loading data, wherein a product of the number of elements multiplied by the element size is not greater than the vector size.

5. An instruction processing device, comprising
a first register adapted to store a target data address;
a second register adapted to store a target data length;
a third vector register adapted to store source data;
a decoder adapted to receive and decode a data storage instruction, the data storage instruction instructing that the first register is a first operand, the second register is a second operand, and the third vector register is a third operand; and
an execution unit coupled to the first register, the second register, the third vector register and the decoder, and executing the decoded data storage instruction, so as to acquire the target data address from the first register, acquire the target data length from the second register, acquire the source data from the third vector register, and store data with a length being based on the target data length in the source data at a position with a start address being the target data address in a memory coupled to the instruction processing device.

6. The instruction processing device according to claim 5, wherein the data storage instruction further instructs an element size, and the execution unit is adapted to store data with the length being based on the element size and the target data length in the source data in the memory,

7. The instruction processing device according to claim 6, wherein the target data length is a number of elements, and the execution unit is adapted to acquire data with a number being the number of elements and the length being the element size from the source data, so as to store the data in the memory.

8. An instruction processing method, comprising;
receiving and decoding a data loading instruction, the data loading instruction instructing that a first register adapted to store a source data address is a first operand, a second register adapted to store a source data length is a second operand, and a third vector register adapted to store target data is a third operand;
acquiring the source data address from the first register:
acquiring the source data length from the second register;
acquiring data with a start address being the source data address and a length being based on the source data length from a memory; and
storing the acquired data as the target data in the third vector register,.

9. The instruction processing method according to claim 8, wherein the data loading instruction further instructs an element size, and the step of acquiring the data from the memory comprises:
calculating a target data length based on the element size and the source data length; and
acquiring the data with the length being the target data length as the target data from the memory.

10. The instruction processing method according to claim 9, wherein the source data length is a number of elements, and the step of acquiring die data from the memory comprises:
acquiring the data with a number being the number of elements and the length being the element size as the target data from the memory.

11. The instruction processing method according to claim 10, wherein the step of acquiring the data from the memory comprises:
loading loading data with the start address being the source data address and the length being a vector size from the memory, wherein a product of the number of elements multiplied by a unit element size is not greater than the vector size: and
acquiring the target data from the loading data.

12. An instruction processing method, comprising:
receiving and decoding a data storage instruction, the data storage instruction instructing that a first register adapted to store a target data address is a first operand, a second register adapted to store a target data length is a second operand, and a third vector register adapted to store source data is a third operand;
acquiring the target data address from the first register;
acquiring the target data length from the second register;
acquiring the source data from the third vector register; and
storing data with a length being based on the target data length in the source data at a position with a start address being the target data address in a memory.

13. The instruction processing method according to claim 12, wherein the data storage instruction further instructs a unit element size, and the step of storing the data in the memory comprises:
storing the data with the length being based on the unit element size and the target data length in the source data in the memory.

14. The instruction processing method according to claim 13, wherein the target data length is a number of elements, and the step of storing the data in the memory comprises:
acquiring the data with a number being the number of elements and the length being the unit element size from the source data, so, as to store the data in the memory.

15. A computing system, comprising:
a memory; and
a processor coupled to the memory and comprising:
a first register adapted to store as source data address;
a second register adapted to store a source data length;
a third vector register adapted to store target data;
a decoder adapted to receive and decode a data loading instruction, the data loading instruction instructing that:
the first register serves as a first operand,
the second register serves as a second operand, and
the third vector register serves as a third operand; and
an execution unit coupled to the first register, the second register, the third vector register and the decoder, and executing the decoded data loading instruction, so as to acquire the source data address from the first register, acquire the source data length from the second register, acquire data with a start address being the source data address and a length being based on the source data length from the memory, and store the acquired data as the target data in the third vector register.

16. The computing system according to claim 15, wherein the data loading instruction further instructs an element size; the source data length is a number of elements; the execution unit is adapted to acquire the data with a number being the number of elements: and the length being the element size as the target data from the memory.

17. The computing system according to claim 16, wherein the execution unit is adapted to load loading data with the start address being the source data, address and the length being a vector size from the memory, and acquire the target data from the loading data, wherein a product of the number of elements multiplied by the element size is not greater than the vector size.

18. A computing system, comprising:
a memory; and
a processor coupled to memory and comprising:
a first register adapted to store a target data address;
a second register adapted to store a target data length;
a third vector register adapted to store source data;
a decoder adapted to receive and decode a data. storage instruction, the data storage instruction instructing that
the first register serves as a first operand,
the second register serves as a second operand, and
the third vector register serves as a third operand; and
an execution unit coupled to the first register, the second register, the third vector register and the decoder, and executing the decoded data storage instruction, so as to acquire the target data address from the first register, acquire the target data length from the second register, acquire the source data from the third vector register, and store data with a length being based on the target data length in the source data at a position with a start address being the target data address in the memory.

19. The computing system according to claim 18, wherein the data storage instruction further instructs an element size, the target data length is a number of elements, and the execution unit is adapted to acquire data with a number being the number of elements and the length being the element size from the source data, so as to store the data in the memory.

20. A machine-readable storage medium, comprising code, wherein when executed, the code causes a machine to execute the method according to claim 8.

21. A system-on-chip, comprising the instruction processing device according to claim 1.
